(19) United States
(12) Patent Application Publication
(10) Pub. No.: US 2009/0166938 A1
(43) Pub. Date: Jul. 2, 2009

(54) Spring Protection Device And Spring Drive Unit Including Spring Protection Device

(76) Inventors: Mats Westfalt, Ludvika (SE); Staffan Jacobsson, Grangarde (SE); Mats Holman, Ludvika (SE)

Correspondence Address: ST. ONGE STEWARD JOHNSTON & REENS, LLC, 986 BEDFORD STREET, STAMFORD, CT, 06905-5619, US

(21) Appl. No.: 12/334,922

(22) Filed: Dec. 15, 2008

(30) Foreign Application Priority Data
Dec. 28, 2007 (EP) 07124146.7

(51) Int. Cl. F16M 1/08

(52) U.S. Cl. 267/140.11

(57) ABSTRACT

The invention relates to spring protection device for a spring drive unit and adapted to surround a spring of the spring drive unit, the protection device comprising a frame plate, against which a first end of the spring rests, and the frame plate being provided with an opening passage for a pullrod connected to the spring. The spring protection device comprises bars with first end parts that are connected to the frame plate, externally of the first end of the spring, and which bars are arranged to extend externally of and along the sides of the spring and externally of a second end of the spring, thereby forming an open cage surrounding the spring. The invention also relates to a spring drive unit comprising a spring protection device.

### CROSS-REFERENCE TO RELATED APPLICATIONS

The present application claims priority of European patent application No. 07124146.7 filed on Dec. 28, 2007, the content of which is incorporated herein by reference.

### FIELD OF THE INVENTION

The present invention relates to a spring protection device for a spring drive unit, e.g. for driving and controlling the opening and closing of an electrical switching apparatus, such as a switch or a circuit breaker. The said switching apparatus is meant to be used in a high or a medium voltage transmission or distribution network and is thus used at voltages ranging from one kilovolt to several hundreds of kilovolts. The spring drive unit may operate circuit breakers of all types, e.g. gas, oil or vacuum insulated circuit breakers of the live tank or dead tank type.

Spring drive units can also be used in other applications. In principle, they may be used anywhere where there is a need to move something very fast.

The present invention also relates to a spring drive unit comprising the inventive spring protection device.

### BACKGROUND OF THE INVENTION

In a power transmission or distribution network, switching apparatuses are incorporated into the network to provide automatic protection in response to abnormal load conditions or to permit opening or closing (switching) of sections of the network. The switching apparatus may therefore be called upon to perform a number of different operations such as interruption of terminal faults or short line faults, interruption of small inductive currents, interruption of capacitive currents, out-of-phase switching or no-load switching, all of which operations are well known to a person skilled in the art.

In switching apparatuses the actual opening or closing operation is carried out by two contacts where normally one is stationary and the other is mobile. The mobile contact is operated by an operating device which comprises an actuator and a mechanism, where said mechanism operatively connects the actuator to the mobile contact.

Actuators of known operating devices for medium and high voltage switches and circuit breakers are of the spring operated, the hydraulic or the electromagnetic type. In the following, operating devices will be described operating a circuit breaker but similar known operating devices may also operate switches.

The spring operated actuator, or spring drive unit as it also is called, generally uses two springs for operating the circuit breaker; an opening spring for opening the circuit breaker and a closing spring for closing the circuit breaker and reloading the opening spring. The closing spring is recharged by an electrical motor which is situated in the operating device. A mechanism converts the motion of the springs into a translation movement of the mobile contact. In its closed position in a network the mobile contact and the stationary contact of the circuit breaker are in contact with each other and the opening spring and the closing spring of the operating device are charged. Upon an opening command the opening spring opens the circuit breaker, separating the contacts. Upon a closing command the closing spring closes the circuit breaker and, at the same time, charges the opening spring. The opening spring is now ready to perform a second opening operation if necessary. When the closing spring has closed the circuit breaker, the electrical motor in the operating device recharges the closing spring. This recharging operation takes several seconds.

It is previously known to use helical springs in spring operated actuators or spring drive units. When the springs are charged or loaded, they are in a compressed state that is not inherently stable. They tend to buckle if they are compressed into the unstable range, and consequently, they require some kind of guiding to prevent buckling. Therefore, in prior art, the springs are enclosed in guiding tubes or cylinders, with a lower end guide plate and the upper end mounted against a frame plate that may be part of the housing for the other parts of the operating device. These guiding tubes also function as protection devices if the spring or other components connected to the spring should break, as they would prevent that broken spring components are thrown around.

In order to make the construction lighter and more cost effective, different alternatives have been contemplated in which the guiding tube can be omitted. However, if the guiding tube is excluded, then there will arise a need for some other type of protection device in order to prevent human injury and further damage to equipment in case of failure.

### SUMMARY OF THE INVENTION

The object of the present invention is to provide a spring protection device for springs in spring drive units in general, and in particular for spring drive units arranged in operating devices for driving and controlling the opening and closing of an electrical switching apparatus, such as a switch or a circuit breaker.

According to the present invention is defined a spring protection device for a spring drive unit and adapted to surround a spring of the spring drive unit, the protection device comprising a frame plate, against which a first end of the spring rests, and the frame plate being provided with an opening passage for a pullrod connected to the spring, characterized in that the spring protection device comprises bars with first end parts that are connected to the frame plate, externally of the first end of the spring, and which bars are arranged to extend externally of and along the sides of the spring and externally of a second end of the spring, thereby forming an open cage surrounding the spring.

This open cage design is light and cost effective, simultaneously with offering the desired protective function.

According to an aspect of the present invention, at least a part of each bar is adapted to absorb energy and deform during an impact from a breaking spring package component, such as the spring itself, the pullrod or other components connected to the spring. In particular, the first end parts of the bars are adapted to absorb energy and deform during an impact from a breaking spring package component.

According to an aspect of the invention, the frame plate has openings through which the respective first ends of the bars are inserted, thereby connecting the bars with the frame plate.

According to another aspect of the invention, the first end parts of the bars are self-locking when inserted through the openings in the frame plate and deformed during an impact from a breaking spring package component.

According to yet another aspect of the invention, the ends of the first end parts of the bars have the general shape of an inverted U and that said inverted U shaped ends are located on top of the frame plate when they have been inserted through the opening.

According to a further aspect of the invention, a portion of the respective first end parts that is located immediately under the frame plate, when the first end part has been inserted through the opening, has a first bend whereby the bar is bent outward from the spring, and a second bend straightening the bar again so that it is essentially coaxial with the spring.

According to still a further aspect of the invention, the respective openings in the frame plates for receiving the first end parts of the bars comprises a first insertion portion that is wide enough for the inverted U-shaped end to be inserted, and a second groove portion that is only wide enough to receive a straight portion of the first end part, which the first end part displays between the inverted U-shaped end and the first bend, such that a first end part of a bar may be inserted through the first insertion portion and then slid into the locking portion.

According to yet a further aspect of the invention, the frame plate is provided with holes arranged for insertion of a locking member that, when inserted, blocks the removal of the first end part from the locking portion of the opening.

According to another aspect of the invention, the bars are connected to each other under the second end of the spring.

The present invention also relates to a spring drive, characterized in that it comprises a spring protection device as defined above.

Further features and advantages of the present invention will become apparent from the following detailed description of the invention.

### BRIEF DESCRIPTION OF THE DRAWINGS

The present invention will now be described in more detail with reference to the enclosed drawings, illustrating an embodiment of the invention as an example only, in which:

FIG. 1 illustrates a spring drive unit provided with a spring protection device according to an embodiment of the present invention,

FIGS. 2-5 show details of the bars of the spring protection device according to one embodiment of the invention, and

FIGS. 6-7 show details of the connection between a bar and the frame plate.

### DETAILED DESCRIPTION OF THE INVENTION

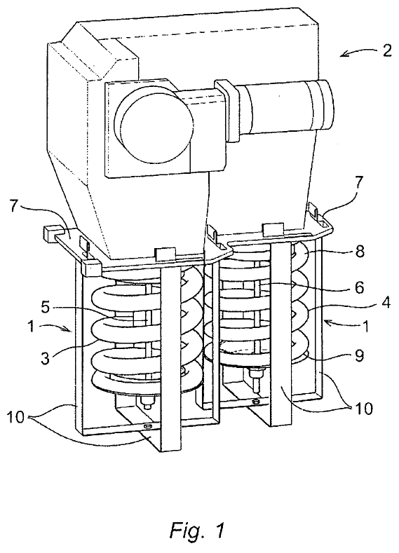

In FIG. 1 is shown an embodiment of a spring protection device 1 according to the present invention, installed on a spring drive unit 2 used in electrical switch gear, such as a circuit breaker for medium and high voltages. The main parts and the operation of a spring drive unit used for circuit breakers and switches have already been described above.

The basic components of a spring drive unit are two springs, one closing spring 3 for closing the switch and one opening spring 4 for opening the switch. Each spring is connected to a charging and discharging mechanism (not shown) inside the housing of the spring drive unit, by means of pullrods 5, 6. Each spring has an upper first end 8 that rests against a frame plate 7 and a lower second end 9 to which the pullrod is connected, e.g. via a spring disc. The frame plate 7 may or may not be part of the housing of the spring drive unit. The springs may have individual frame plates or a common frame plate. The frame plate is preferably provided with some kind of guiding means for the spring. The frame plate is also provided with an opening passage for the pullrod of each respective spring. Since the spring protection device is identical for both the opening spring 4 and the closing spring 3, some of the reference numbers will only be written out in FIG. 1 for one of the springs, namely the opening spring.

The spring protection device 1 further comprises bars 10 that are connected to the frame plate 7, externally of each spring 3, 4, and that extend externally of and along the sides of the spring and under the lower second end 9 of the spring. In this way an open cage surrounding the spring is formed. In the following this cage is referred to as the protection cage.

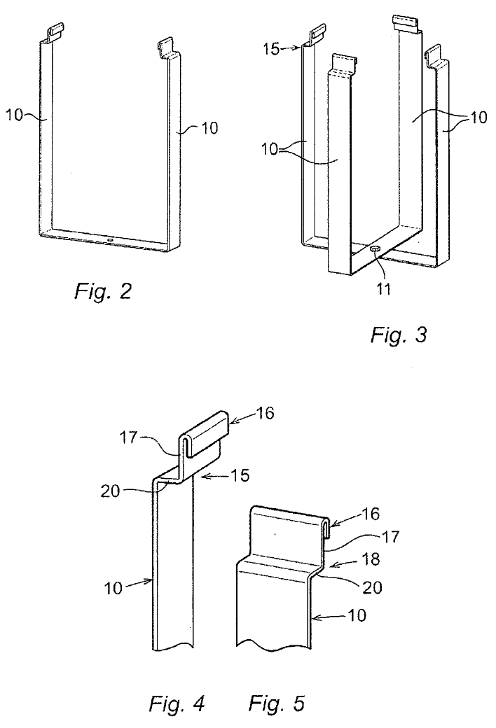

The bars 10 are shown in more detail in FIGS. 2-5. In the illustrated embodiment, the bars are made from flat bars of steel that are bent into the required shape. It is important that the bars should be made from a material having high bending capability and strength in order to achieve the required energy absorption by partially straightening the bends during impact, as will be explained below. Also other materials and shapes satisfying these criteria are of course possible within the scope of the invention.

According to the illustrated embodiment in FIGS. 2 and 3, the protection cage is formed by two U-shaped elements that are placed with their transverse bottom legs crossing each other at right angles. These two U-shaped elements together provide four bars 10. In the illustrated embodiment, the U-shaped elements are connected where they cross, with a connection device 11, for example a screw. However, it should be noted that this is optional. Furthermore, it would also be conceivable to have four separate bars which are in some way connected to each other at a suitable bottom point for stabilization purposes. Also, the number of bars is not restricted to four, but can be varied depending on the material in the bars, the force in the compressed spring etc. In addition, the bottom parts of the bars do not have to be at right angles with the side portions of the bars, but could for example form an obtuse angle.

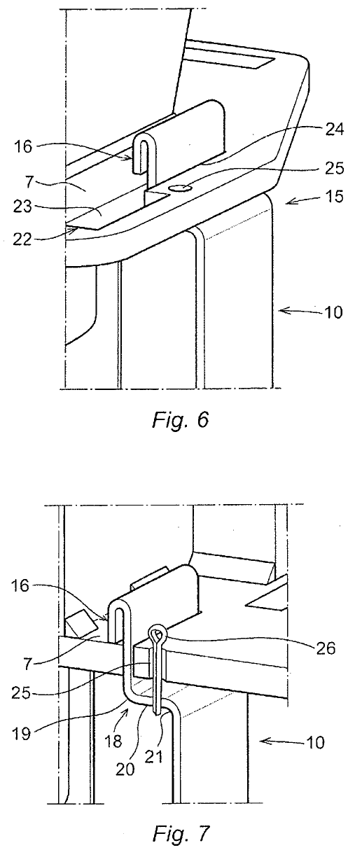

Each bar 10 has an upper first end part 15 that is connected to the frame plate 7, as can be seen in FIGS. 4-7. The end 16 of the first end part 15 has the general shape of an inverted U and is located on the top of the frame plate 7 when the end 16 has been inserted through an opening 22 provided for this purpose in the frame plate 8. By U-shaped is meant that the end 16 of the bar 10 is bent 180° or a little more. This shape is chosen for its ability to absorb deformation forces during which the U-legs are bent apart.

Before the inverted U-shaped end 16, the first end part 15 has a portion 17 that is straight and coaxial with the spring. This straight portion 17 has approximately a length that is slightly longer than the thickness of the frame plate. Immediately under the frame plate 7, there is a portion 18 of the first end part 15, having a locking function. This locking portion 18 has a first bend 19 facing away from the spring and resulting in an angular bar portion 20 forming an angle of approximately 90° in relation to the spring axis. One purpose of this angular bar portion is to stop the parts of the bar that are below the frame plate 7 from entering into the opening 22. The angle is not necessarily 90°, but may vary, within an approximate range from 40° to 140°. In most cases the angle would be within 90°±10°.

Before the angular bar portion 20, there is a second bend 21 by means of which the bar resumes its straight shape coaxial with the spring and parallel to the straight portion 17 described above.

The opening 22 in the frame plate 7 for receiving the end 16 of the first end part 15 of the bar 10, comprises a first insertion portion 23 that is wide enough for the inverted U-shaped end 16 to be inserted, and a second groove portion 24. The groove portion 24 is only wide enough to receive the straight portion 17 of the first end part 15. When mounting the bar in the frame, the inverted U-shaped end 16 is inserted through the insertion portion 23 of the opening. The bar is then slid into the groove portion 24, by means of the straight portion 17 entering the groove, the inverted U-shaped end 16 being on top of the frame plate 7 and the remaining parts of the bar being under the frame plate. This can be seen in FIG. 7 where some parts have been cut away for a clearer view. The first end part 15 of the bar is then locked in the groove from any movement coaxial with the spring. In order also to prevent the first end part 15 from sliding out of the groove portion 24, there is a hole 25 provided in the frame plate for insertion of a locking member 26 that, when inserted, blocks the sliding of the first end part back into the insertion portion 23 of the opening. In the illustrated embodiment, the locking member is a simple cotter pin 26, but also other similar devices are of course possible.

In addition to the connection and locking functions described above, the different shapes of the first end part 15 are adapted to absorb energy and deform during an impact from a breaking spring. This will result in different degrees of deformation and straightening out of the bent parts, but they will not come loose since their shape is designed such that they are self-locking.

The present invention is not limited to the described embodiment, given as example only, but can be modified in various ways by a person skilled in the art within the scope as defined in the appended patent claims.

1. Spring protection device for a spring drive unit and adapted to surround a spring of the spring drive unit, the protection device comprising a frame plate, against which a first end of the spring rests, and the frame plate being provided with an opening passage for a pullrod connected to the spring, characterized in that the spring protection device comprises bars with first end parts that are connected to the frame plate, externally of the first end of the spring, and which bars are arranged to extend externally of and along the sides of the spring and externally of a second end of the spring, thereby forming an open cage surrounding the spring.

2. Spring protection device according to claim 1, characterized in that at least a part of each bar is adapted to absorb energy and deform during an impact from a breaking spring package component.

3. Spring protection device according to claim 2, characterized in that the first end parts of the bars are adapted to absorb energy and deform during an impact from a breaking spring package component.

4. Spring protection device according to claim 1, characterized in that the frame plate has openings through which the respective first ends of the bars are inserted, thereby connecting the bars with the frame plate.

5. Spring protection device according to claim 4, characterized in that the first end parts of the bars are self-locking when inserted through the openings in the frame plate and deformed during an impact from a breaking spring package component.

6. Spring protection device according to claim 5, characterized in that the ends of the first end parts of the bars have the general shape of an inverted U and that said inverted U-shaped ends are located on top of the frame plate when they have been inserted through the opening.

7. Spring protection device according to claim 4, characterized in that a portion of the respective first end parts that is located immediately under the frame plate, when the first end part has been inserted through the opening, has a first bend whereby the bar is bent outward from the spring, and a second bend straightening the bar again so that it is essentially coaxial with the spring.

8. Spring protection device according to claim 7, characterized in that the respective openings in the frame plates for receiving the first end parts of the bars comprise a first insertion portion that is wide enough for the inverted U shaped ends to be inserted, and a second groove portion that is only wide enough to receive a straight portion of the first end part, which the first end part displays between the inverted U-shaped end and the first bend, such that a first end part of a bar may be inserted through the first insertion portion and then slid into the groove portion.

9. Spring protection device according to claim 8, characterized in that the frame plate is provided with holes arranged for insertion of a locking member that, when inserted, blocks the removal of the first end part from the groove portion of the opening.

10. Spring protection device according to claim 1, characterized in that the bars are connected to each other under the second end of the spring.

11. A spring drive unit, comprising a spring protection device adapted to surround a spring of the spring drive unit, the protection device comprising a frame plate, against which a first end of the spring rests, and the frame plate being provided with an opening passage for a pullrod connected to the spring, characterized in that the spring protection device comprises bars with first end parts that are connected to the frame plate, externally of the first end of the spring, and which bars are arranged to extend externally of and along the sides of the spring and externally of a second end of the spring, thereby forming an open cage surrounding the spring.
